(19) United States
(12) Patent Application Publication
(10) Pub. No.: US 2015/0359291 A1
(43) Pub. Date: Dec. 17, 2015

(54) AUTOMATIC PEDOMETER AND AUTOMATIC STEP-COUNTING SHOE

(71) Applicant: Shen-Ko Tseng, Taipei (TW)

(72) Inventor: Shen-Ko Tseng, Taipei (TW)

(21) Appl. No.: 14/305,801

(22) Filed: Jun. 16, 2014

(51) Int. Cl. A43B 3/00; G01C 22/00; G01P 15/02; A43B 23/24

(52) U.S. Cl. CPC A43B 3/0015; A43B 23/24; G01C 22/006; G01P 15/02

(57) ABSTRACT

The present invention provides an automatic pedometer comprising a power generation module, a step-counting module, and a display module. The power generation module stores an electric energy and supplies the electric energy. The step-counting module receives the electric energy from the power generation module and senses a user's motion by a solid-state three-axis acceleration sensor chip to counting the step count. The display module shows the step count to the user. By the design of the present invention, the user can count the steps of exercise or jogs precisely.

### FIELD OF THE INVENTION

The present invention relates to an automatic pedometer, and more particularly, to an automatic step-counting shoe by integrating a step-counting module and a display module for counting and displaying the step count that users step.

### BACKGROUND OF THE INVENTION

With the continuous progress of the times, people increasingly realize the importance of sports. People always need a pedometer for understanding the step count during the exercise. But user may feel uncomfortable while using the pedometer because the pedometer is tying on a limb too much or too slippery. A solution for that problem is to tie the pedometer with a shoe. On the other hand, some of the present pedometers are counting steps by using vibration switches, or using piezoelectric material in some electronic pedometer. All these pedometers have a limitation in accuracy. How to improve the accuracy of the pedometer has become the problem that manufacturer of the pedometer works so hard on it.

### SUMMARY OF THE INVENTION

Therefore, in order to improve the problem described previously, a scope of the present invention is to provide an automatic pedometer and an automatic step-counting shoe which can sense the step count that the user steps precisely. According to one embodiment, the automatic pedometer comprises a power generation module, a step-counting module, and a display module. Wherein, the step-counting module is coupled to the power generation module and comprises a solid-state three-axis acceleration sensor chip, for sensing a first axis acceleration, a second axis acceleration and a third axis acceleration according to an external force applied to the step-counting module. The step-counting module is utilized for recording a step count. The display module is coupled to the power generation module. The display module has at least one LED unit, and is utilized for showing the step count.

The automatic pedometer of the present invention can optionally comprise a control module and a second display module. The control module is coupled to the step-counting module and the display module, for controlling the display module to displaying the step count. The second display module is coupled with the power generation module. The second display module has an at least one LED unit and is utilized for showing the remaining energy of the power generation module.

The automatic step-counting shoe of present invention is applied with stepping on a floor, and comprises a shoe body, a power generation module, a step-counting module, and a display module. The power generation module is deposed in the bottom of the shoe body, for storing an electrical power. The step-counting module is deposed in the bottom of the shoe body, and coupled to the power generation module for recording a step count. The step-counting module comprises a solid-state three-axis acceleration sensor chip, for sensing a first axis acceleration, a second axis acceleration and a third axis acceleration according to an external force applied to the step-counting module and sensing the steps when the user exercises or jogs. Meanwhile, the display module is deposed at the outside surface, and coupled to the power generation module, for displaying the step count when the user exercises or jogs.

In addition, the automatic step-counting shoe of the present invention can optionally comprise a control module, a second display module, an interface module, and a reset module. Wherein, the control module is coupled to the step-counting module and the display module, for controlling the display module to showing the step count. The second display module is deposed on the outer surface of the shoe body and coupled with the power generation module. The second display module has an at least one LED unit, and is utilized for showing the remaining energy of the power generation module. The interface module is deposed on the outside of the shoe body and coupled with the power generation module for coupling with an external electronic module. The external electronic module is charging the power generation module via the interface module or vice versa.

In one embodiment, the luminous color or the luminous frequency is corresponding to the number of step-counting. In this design, the luminous direction of the display module is facing to the floor. In addition, when the step count is in a first section, a second section, and a third section, the luminous colors of each section are a first color, a second color, and a third color, such as red, yellow, and green. The first section is smaller than the second section, and the second section is smaller than the third section. For example, the first section referring to the interval is less than 1,000 steps. The second section referring to the interval is between 1,001 to 10,000 steps. The third section referring to the interval is greater than 10,001 steps. The reset module is connected to the step-counting module for resetting the step-counting module to re-counting steps.

Furthermore, in another embodiment, except for the shoe body, the power generation module, the step-counting module, and the display module which are mentioned above, the automatic step-counting shoe of the present invention further comprises a shell. The shell is deposed on the outer surface of the shoe body and has a containing space and a shell surface. The difference between the present design and previous design is that the power generation module and the step-counting module are all deposed in the containing space, and the display module is deposed on the surface of the shell. In actual application, the design of the present invention can optionally comprise a control module and a second display module. Wherein the control module and the second display module are in essence the same with the embodiment mentioned previously, thus these components need not be elaborated. The difference between the present design and previous design is that the control module is deposed in the containing space, and the second display module is deposed on the surface of the shell.

In summary, the automatic step-counting shoe of the present invention senses the steps via the solid-state three-axis acceleration sensor chip for solving the problem of low accuracy on sensing stepping.

The advantage and spirit of the invention may be understood by the following recitations together with the appended drawings.

### BRIEF DESCRIPTION OF THE DRAWINGS

FIG. 1 is a schematic diagram illustrating an automatic step-counting shoe according to one embodiment of the invention.

FIG. 2 is a schematic diagram illustrating an automatic step-counting shoe according to another embodiment of the invention.

FIG. 3 is a circuit diagram of a step-counting module according to one embodiment of the invention.

FIG. 4 is a circuit diagram of a control module and a display module according to one embodiment of the invention.

### DETAILED DESCRIPTION

The embodiments and the practical applications of the present invention will be described in the following paragraphs, so as to sufficiently explain the characteristics, spirits, and advantages of the invention.

The automatic pedometer of the invention comprises a power generation module 10, a step-counting module 30, and a display module 60. Wherein, the step-counting module 30 is coupled to the power generation module and comprises a solid-state three-axis acceleration sensor chip. The sensor chip senses a first axis acceleration, a second axis acceleration and a third axis acceleration according to an external force applied to the step-counting module 30. The display module 60 is coupled to the power generation module 10. The display module 60 has an at least one LED unit, and is utilized for showing the step count.

The automatic pedometer of the present invention can further comprise a control module 40 and a second display module 70. The control module 40 coupled to the step-counting module 30 and the display module 60, for accumulating the step count when the user exercises or jogs and controlling the display module to displaying the step count. The second display 70 module is coupled with the power generation module 10. The second display module 70 has an at least one LED unit, and is utilized for showing the remaining energy of the power generation module 10.

According to the application of the solid-state three-axis acceleration sensor chip, the steps when the user exercises or jogs will be precisely calculated. According to the invention, a determination criterion has to be designed. By comparing the sensing values of the first axis acceleration, the second axis acceleration and the third axis acceleration with the determination criteria, the step-counting module 30 can analyze the stepping pattern of the user and further determine whether the user has stepped.

For example, the solid-state three-axis acceleration sensor chip further comprises three registers for storing the sensing values of the first axis acceleration, the second axis acceleration and the third axis acceleration respectively. The solid-state three-axis acceleration sensor chip is coupled to the control module 40 and transmitting signals, so the control module 40 can read the sensing values of the first axis acceleration, the second axis acceleration and the third axis acceleration which are stored in the three registers.

In one embodiment, the transmitting signals comprise a serial data line (SDA) signal and a serial clock line (SCL) signal both for I2C bus specification, the sensing values stored in the three registers are serially read. The determination criteria can be the computed values by individually squaring, then adding, and then square rooting the sensing values of the first axis acceleration, the second axis acceleration and the third axis acceleration respectively. If the computing values are greater than a default value, then the user is stepped. And the control module 40 accumulates the step count when the user exercises or jogs and controls the display module 60 to display the step count.

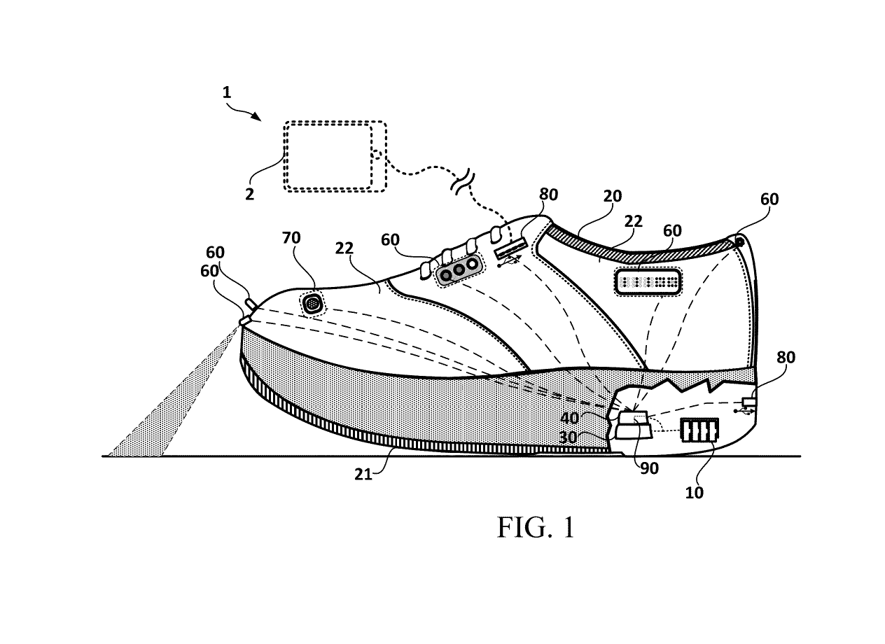

In addition, the present invention discloses an automatic step-counting shoe 1 for recording and showing the step count taken in walking. Please refer to FIG. 1. FIG. 1 is a schematic diagram illustrating an automatic step-counting shoe 1 according to one embodiment of the invention. As shown in FIG. 1, the automatic step-counting shoe 1 comprises a power generation module 10, a shoe body 20, a step-counting module 30, a control module 40, a display module 60, a second display module 70, an interface module 80, and a reset module 90. Wherein, the shoe body 20, the step-counting module 30, and the display module 60 are the essential components, and the other components can be omitted if necessary.

The shoe body 20 comprises a bottom 21 and an outer surface 22. The shoe body 20 bears an external force when user is walking. In the embodiment, the external force is acceleration or acting force resulting from walking. In addition, the outer surface 22 mentioned above signifies the exterior of the shoe body 20 (as shown in FIG. 1) or the surface opposite to user's foot stepping direction. It is worth noting that the outer surface 22 mentioned above is not only limited to the top surface of the shoe body 20, but also the front or rear outer surface of the shoe body 20.

The power generation module 10 is used for storing electrical energy and providing electrical energy to the other modules or devices. In the embodiment, the power generation module 10 is configured to the bottom 21 of the shoe body 20, and formed by connecting button cell batteries in series. Wherein, the power generation module 10 can be configured on the rear of bottom 21 near user's heel, the middle of bottom 21, or other effective position. Additionally, the shapes, the numbers, and the connection pattern of the component (batteries) of the power generation module 10 can be changed corresponding to the deposed position of the power generation module 10. For example, the power generation module 10 can be a single plate-type rechargeable battery or any other type battery, such as lithium battery. Besides, the power generation module 10 can also be a power generator, such as a film-like piezoelectric material or formed by power generating components which is utilizing electromotive force for power generating.

The step-counting module 30 is coupled with the power generation module 10 to obtain electrical energy. The step-counting module 30 is used for counting a step count that user exercises or jogs. Wherein, the step-counting module 30 comprises a solid-state three-axis acceleration sensor chip. The solid-state three-axis acceleration sensor chip is a semi-conductive micro mechanical acceleration sensing chip for sensing a first axis acceleration, a second axis acceleration and a third axis acceleration. In an embodiment, the three axes can be the X-axis, the Y-axis, and the Z-axis of the Cartesian coordinate system. That means the sensor chip mentioned above has the ability to sense the acceleration of the three axes of the Cartesian coordinate system. While bearing accelerations, the micro mechanical semi-conductive component of the sensor chip will generate the sensing values, and then compute the sensing values for calculating the acceleration of each axis.

With the application of the solid-state three-axis acceleration sensor chip, the situation of user stepping can be precisely controlled. According to this invention, the designer has a pre-set determination criteria in the sensor chip or inputted from other device, based on the comparison of the sensing values of different axes with the determination criteria. So the stepping pattern of the user can be analyzed and further sense the motion of the user.

On the other hand, the display module 60 is coupled with the power generation module 10 described above, and utilized for displaying the step count when the user exercises or jogs, and meanwhile, the display module 60 has an at least one LED unit. As shown in FIG. 1, the display module 60 can be configured on any position of the outer surface 22 of the shoe body 20 discretionarily. In order to read the value easily, the display module 60 is recommended to be configured near the shoelace or the front end of the shoe body 20. The display module 60 can also be configured on the rear end of the shoe body 20 as an annunciation lamp as shown in FIG. 1.

To be noticed, the multiple display modules 60 shown in FIG. 1 is a possible design that the display module 60 can be configured on any position of the outer surface 22 of the shoe body 20 discretionarily, wherein the present invention is not limited in multiple display modules 60.

For examples, the display module 60 has an at least one LED unit, every LED unit comprises a LED module that comprises at least a LED chip, such as an SMD (surface-mounted device) LED or a lamp LED. FIG. 1 has revealed several possible design of the display module 60.

In one embodiment, the display module 60 is composed of a plurality of LED units, wherein the LED units are arranged in two-dimensional matrix and used for showing the step count with a two-dimensional image. To be noticed, the display module 60 is not limited to show characters. According to user's demands, the expression of the step count can be a pattern, symbol, or amount of luminous spots. For example, when the amount of luminous spots is one, the step count is larger than 1,000; when the amount of luminous spots is two, the number is larger than 5,000; when the amount of luminous spots is three, the number is larger than 10,000.

Additionally the display module 60 also can show the step count with different flicker frequency of light, for example the flicker frequency of light changes corresponding to the accumulation of user's steps.

Or the display module 60 can show the step count with different luminous colors or luminous intensity. More specifically, the LED units of the display module 60 can comprise, but not limited to, three light emitting diode chips with wavelengths corresponding to three primary colors respectively. With the variation of the step count, the three light emitting diode chips can generate different colors correspondingly. For example, when the step count is less than 1,000, the display device 60 emits red light; when the step count is between 1,000 and 10,000, the display device 60 emits yellow light; and when the number is larger than 10,000, the display device 60 emits green light. Therefore, users can know their step count by recognizing the luminous colors facilely.

On the other hand, when the step count is in a first section, a second section, and a third section, the luminous colors of each section are a first color, a second color, and a third color. In the embodiment, the first color, the second color, and the third color are red, yellow, and green respectively. The first section is smaller than the second section; the second section is smaller than the third section. In the embodiment, the first section referring to the interval is less than 1,000 steps. The second section referring to the interval is between 1,001 to 10,000 steps. The third section referring to the interval is greater than 10,001 steps.

In actual application, it is worth noting that, the relationship between the luminous color and the luminous frequency of the present invention is on designer's demand. Meanwhile, the display module 60 emits the light toward the road and shows the step count to user via the reflection of light from the floor and the road. In addition, the display module 60 shows the step count by utilizing a Black-and-white or a color LCD.

In addition, the control module 40 can be coupled with each module in the present invention or be coupled with all the modules at the same time. The primary function of the control module 40 is to control the display module 60, so as to show the step count recorded by the step-counting device 30. For examples, the control module 40 controls the step-counting module 30 or the display module 60, or further controls the display module 60 according to the signals of the step-counting module 30 with changing the luminous frequency, luminous color, and luminous intensity for showing the steps that the step-counting module 30 sensing. In this embodiment, the control module 40 is composed of printed circuit boards (PCB) and operational circuit, and the control module 40 can obtain power source from the power generation module 10 and the electricity storing module 50. To be noticed, the control module 40 described above can be integrated into the step-counting module 30.

Additionally, the automatic step-counting shoe 1 optionally comprises a switch 41 for controlling the open circuit or break circuit of the control module 40. The switch 41 can be a push switch embedded on the surface of the control module 40, and trigger by the external force transferred to the shoe body 20. Furthermore, the switch 41 can be deposed on the outer surface 22 of the shoe body 20 and connected to the control module 40 via a wire or other approaches for manual control.

Additionally, the control module 40 can have an automatic activate/deactivate function. When the control module 40 is not receiving the signals from the switch 41, which the signals is generated by the external force transferred to the shoe body 20. The control module 40 will automatically deactivate for saving electricity. But the control module 40 will automatically activate by the motion of the shoe body 20.

In this embodiment, the step-counting shoe 1 can comprise an interface module 80. The interface module 80 can be compatible with USB 2.0 or USB 3.0 specification depending on the needs of users. In this embodiment, the interface module 80 is coupled with the power generation module 10. So that the power generation module 10 can be charged by the external electronic module 2 via a wire, or the external electronic module 2 can be charged by the power generation module 10 via a wire.

In the embodiment, the interface module 80 is configured on the outer surface 22 of the shoe body 20 so as to be convenient for the connector of the external electronic module 2 to plug in. Wherein, the external electronic module 2 is a mobile phone, a power bank, or a rechargeable battery. However, the interface module 80 can be embedded into the bottom 21 of the shoe body 20 and expose a corresponding connecting plug for the connector of the external electronic module 2 to plug in. Moreover, the interface device 80 described above can further comprise a cover for protecting the interface module 80 when it need not be used. When there is a need for transferring electricity, the user can couple the external electronic module 2 to the power generation module 10 for supplying the direct current to an external electronic module 2.

Furthermore, the present invention can comprise a second display module 70 optionally. As shown in FIG. 1, the second display module 70 can be added on the outer surface 22 of the shoe body 20. The second display module 70 is coupled with the power generation module 10 and utilized for showing the remaining energy of the power generation module 10. To be more precise, the second display module 70 evaluates the remaining energy according to the output voltage or output current, and meanwhile, the second display module 70 has an at least one LED unit so as to show the remaining energy with different colors. For example, when the remaining energy of the power generation module 10 is between 61% and 100%, the second display module 70 emits green light; when the remaining energy is between 21% and 60%, the second display module 70 emits blue light; and when the remaining energy is lower than 20%, the second display module 70 emits red light. Moreover, the second display module 70 can show the remaining energy by other manners, such as the amount of luminous spots or the flicker frequency of light.

Furthermore, the present invention can comprise a reset module 90 optionally. The reset module 90 is coupled with the step-counting module 30 for resetting the step-counting of the step-counting module 30. In the embodiment, the reset module 90 can optionally integrate in the control module 40, or be an independent control device or chip having the function mentioned above. While the reset module 90 is on, the reset module 90 will automatically reset the steps that the display module 60 shows or the step-counting module 30 records based on a pre-set condition.

In the embodiment, the pre-set condition is a pre-set time period. For example, when the pre-set time period is one day, the reset module 90 will automatically reset the step count recorded by the step-counting module 30, or the step count showed by the display module 60 to zero for user to know the steps that walking. To be noticed, the pre-set time period can also be a minute, an hour, a week, and a month. Besides, the pre-set condition is not limited to the pre-set time period that mentioned above, the pre-set condition can also be an idle time period.

For example, when the number of step is not increasing in the idle time period, such as three hours, the number of the step recorded by the step-counting module will be reset to zero for user to know the step count in a continuous exercising. In addition, the reset module 90 is coupled with a reset interface (not shown in FIG. 1) which is deposed on the outer surface 22 of the shoe body 20 for resetting the step count recorded by the step-counting module 30, or the step count showed by the display module 60 to zero manually. The reset interface can be optionally deposed or integrated in the exterior switch of the control module 40.

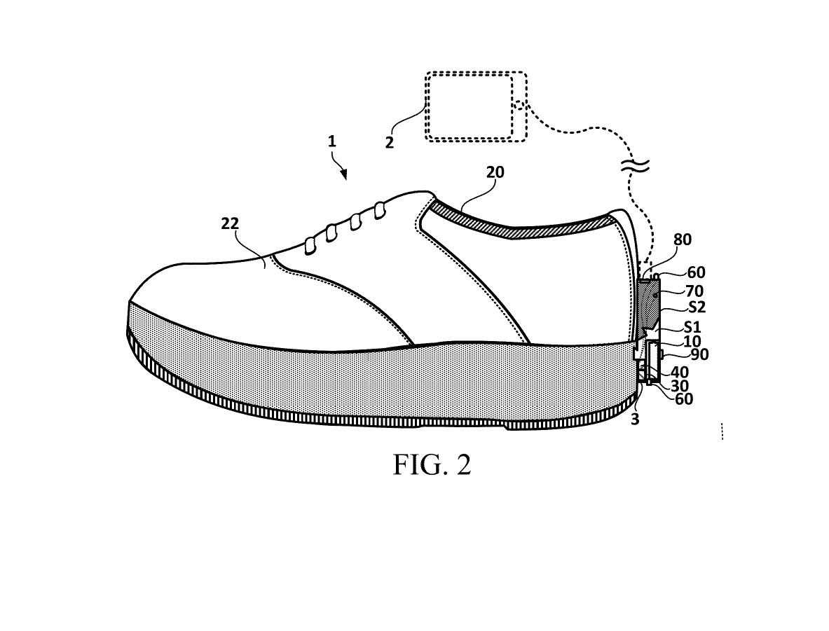

Please refer to FIG. 2. FIG. 2 is a schematic diagram illustrating an automatic step-counting shoe according to another embodiment of the invention. In this embodiment, the component and the design are very similar to the embodiment mentioned above. Here only point out the difference between the present embodiment and the embodiment mentioned above.

Compared to the embodiment mentioned above, the shoe body 20 of the present embodiment further comprises a shell 3. The shell 3 has a containing space S1 and a shell surface S2 for loading or containing the component mentioned above. For example, the power generation module 10, the step-counting module 30, and the control module 40 are deposed in the containing space S1. The display module 60, the second display module 70, and the interface module 80 are deposed on the shell surface S2. In this embodiment, the surface of the shell 3 can further comprise a movable cover (not shown in FIG. 2); the user can open the cover for pull out or exchange the power generation module 10.

Additionally, the shell 3 has a clasping mechanism for clasping the shell 3 to the outer surface 22 of the shoe body 20, but is not limited to this manner. The designer may use other conventional fixing means to fixing the shell 3 on the outer surface 22 of the shoe body 20.

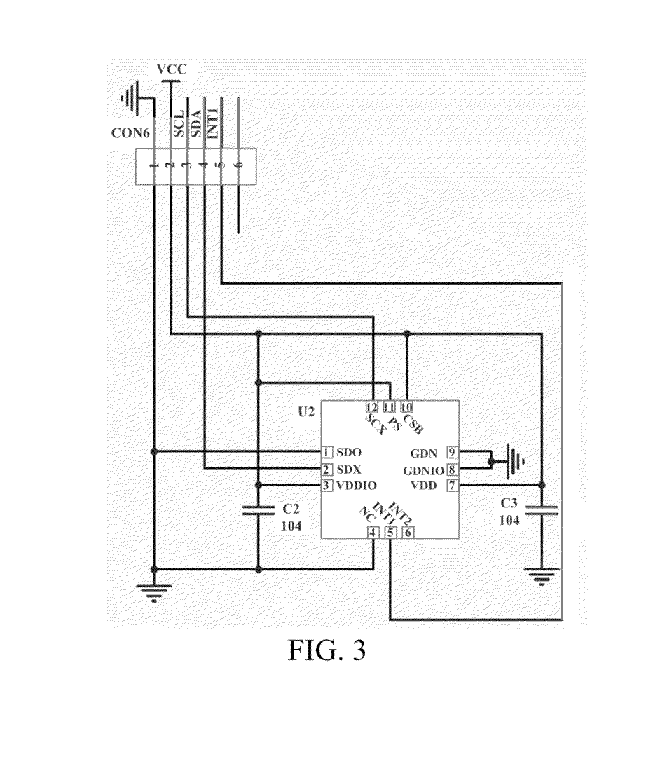

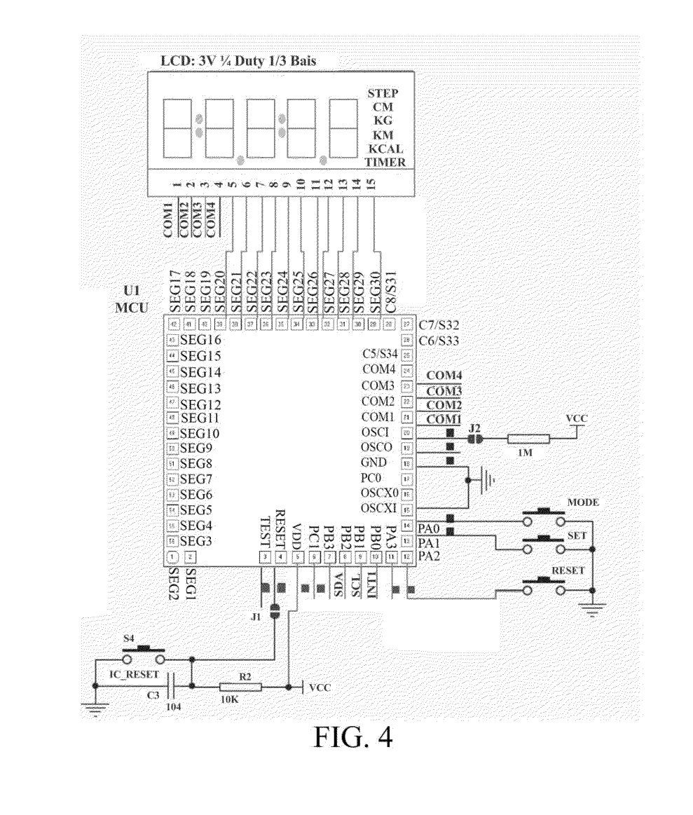

Finally, please refer to FIG. 3 and FIG. 4. FIG. 3 is a circuit diagram of a step-counting module according to one embodiment of the invention. Wherein, the solid-state three-axis acceleration sensor chip of the step-counting module 30 further comprises three registers for storing the sensing values of the first axis acceleration, the second axis acceleration and the third axis acceleration respectively. FIG. 4 is a circuit diagram of a control module and a display module according to one embodiment of the invention.

Because the relative relationship of each component in FIG. 3 and FIG. 4 has been clearly illustrated, the applicant will not pay more attention to repeat description. But it need to be emphasized that the full details of the plan referred depicted, including wiring methods, the contact position, the port connected to the relationship between various components, etc., should have as a basis for the amendment of the specification in the future.

As shown in FIG. 3 and FIG. 4, the sensor chip is coupled with the control module 40 for reading the sensing values of different axes of the sensor chip via the INT1 signal, the SCL signal, and the SDA signal. In one embodiment, the SCL signals and the SDA signals which are belonged to the specifications of I2C bus, reading the sensing values of the first axis acceleration, the second axis acceleration and the third axis acceleration which are stored in the three registers. After reading the sensing values, the control module 40 compares the sensing values with the determination criteria which are mentioned above, for determining whether the user is stepping.

Wherein, the determination criteria can be the computing values by first individually squaring, then adding, and square rooting the sensing values of the first axis acceleration, the second axis acceleration and the third axis acceleration. If the computing values are greater than a default value, then the user is determined to step.

Please refer to FIG. 4. FIG. 4 is a circuit diagram of a control module and a display module according to one embodiment of the invention. As shown in the FIG. 4, in the embodiment, the control module 40 is coupled with the display module 60 via port 29 to port 30. The display module 60 can be a LCD and not only show the step count, but also show user's height, weight, walking distance, burning calories, and walking times by coupling with proper micro device or program.

In summary, the automatic step-counting shoe of the present invention has a solid-state semi-conductive sensor chip for sensing three-dimensional acceleration, then counting the step count precisely.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

1. An automatic pedometer, used for displaying a step count when a user exercises or jogs, comprising:
a power generation module, for storing an electrical power;
a step-counting module, coupled to the power generation module and comprising:
a solid-state three-axis acceleration sensor chip, for sensing a first axis acceleration, a second axis acceleration and a third axis acceleration according to an external force applied to the step-counting module; and
a display module, coupled to the power generation module, for displaying the step count when the user exercises or jogs.

2. The automatic pedometer of claim 1, further comprising a control module coupled the step-counting module and the display module, for determining whether the user has stepped according to a determination criterion and the sensing values of the first axis acceleration, the second axis acceleration and the third axis acceleration.

3. The automatic pedometer of claim 2, wherein the control module accumulates the step count when the user exercises or jogs and controls the display module to display the step count.

4. The automatic pedometer of claim 3, wherein the solid-state three-axis acceleration sensor chip further comprises three registers for storing the sensing values of the first axis acceleration, the second axis acceleration and the third axis acceleration respectively.

5. The automatic pedometer of claim 4, wherein the control module is coupled to the solid-state three-axis acceleration sensor chip through a serial data line (SDA) and a serial clock line (SCL) both for I2C bus specification, and serially reads the sensing values of the first axis acceleration, the second axis acceleration and the third axis acceleration respectively stored in the three registers of the solid-state three-axis acceleration sensor chip.

6. An automatic step-counting shoe, used for displaying a step count when a user exercises or jogs, comprising:
a shoe body, having an outside surface and a bottom;
a power generation module, deposed in the bottom, for storing an electrical power; a step-counting module, deposed in the bottom, coupled to the power generation module and comprising:
a solid-state three-axis acceleration sensor chip, for sensing a first axis acceleration, a second axis acceleration and a third axis acceleration according to an external force applied to the step-counting module; and
a display module, deposed at the outside surface, coupled to the power generation module, for displaying the step count when the user exercises or jogs.

7. The automatic step-counting shoe of claim 6, wherein the display module further comprises a light-emitting diode unit, the luminous color or the luminous frequency of the light-emitting diode unit is corresponding to the step count.

8. The automatic step-counting shoe of claim 6, further comprising:
a control module, coupled the step-counting module and the display module, for determining whether the user has stepped according to a determination criteria and the sensing values of the first axis acceleration, the second axis acceleration and the third axis acceleration.
The automatic step-counting shoe of claim 8, wherein the control module accumulates the step count when the user exercises or jogs and controls the display module to display the step count.

9. The automatic pedometer of claim 6, wherein the solid-state three-axis acceleration sensor chip further comprises three registers for storing the sensing values of the first axis acceleration, the second axis acceleration and the third axis acceleration respectively.

10. The automatic step-counting shoe of claim 6, further comprising:
an interface module, coupled to the power generation module, for coupling the power generation module to an external electronic module so that the power generation module can be charged by the external electronic module, or the external electronic module can be charged by the power generation module.

11. The automatic step-counting shoe of claim 6, further comprising:
a second display module, deposed at the outside surface, coupled to the power generation module and comprising at least one light-emitting diode unit for displaying a remaining power of the power generation module;
wherein the luminous color for the light-emitting diode unit of the second display module is corresponding to the remaining power.
